(19) United States
(12) Patent Application Publication
(10) Pub. No.: US 2002/0087306 A1
(43) Pub. Date: Jul. 4, 2002

(54) Computer-implemented noise normalization method and system

(76) Inventors: Victor Wai Leung Lee, Waterloo (CA); Otman A. Basir, Kitchener (CA); Fakhreddine O. Karray, Waterloo (CA); Jiping Sun, Waterloo (CA); Xing Jing, Waterloo (CA)

Correspondence Address: John V. Biernacki, Esq., Jones, Day, Reavis & Pogue, North Point, 901 Lakeside Avenue, Cleveland, OH, 44114, US

(21) Appl. No.: 09/863,939

(22) Filed: May 23, 2001

Related U.S. Application Data
(60) Provisional application No. 60/258,911, filed on Dec. 29, 2000.

(51) Int. Cl. G10L 15/20

(52) U.S. Cl. 704/233

(57) ABSTRACT

A computer-implemented speech recognition method and system for handling noise contained in a user input speech. The user input speech from a user contains environmental noise, user vocalized noise, and useful sounds. A domain acoustic noise model is selected from a plurality of candidate domain acoustic noise models that substantially matches the acoustic profile of the environmental noise in the user input speech. Each of the candidate domain acoustic noise models contains a noise acoustic profile specific to a pre-selected domain. An environmental noise language model is adjusted based upon the selected domain acoustic noise model and is used to detect the environmental noise within the user input speech. A vocalized noise model is adjusted based upon the selected domain acoustic noise model and is used to detect the vocalized noise within the user input speech. A language model is adjusted based upon the selected domain acoustic noise model and is used to detect the useful sounds within the user input speech. Speech recognition is performed upon the user input speech using the adjusted environmental noise language model, the adjusted vocalized noise model, and the adjusted language model.

### RELATED APPLICATION

This application claims priority to U.S. provisional application Serial No. 60/258,911 entitled “Voice Portal Management System and Method” filed Dec. 29, 2000. By this reference, the full disclosure, including the drawings, of U.S. provisional application Serial No. 60/258,911 are incorporated herein.

### FIELD OF THE INVENTION

The present invention relates generally to computer speech processing systems and more particularly, to computer systems that recognize speech.

### BACKGROUND AND SUMMARY OF THE INVENTION

Speech recognition systems are increasingly being used in computer service applications because they are a more natural way for information to be acquired from and provided to people. For example, speech recognition systems are used in telephony applications where a user through a communication device requests that a service be performed. The user may be requesting weather information to plan a trip to Chicago. Accordingly, the user may ask what is the temperature expected to be in Chicago on Monday.

Wireless communication devices, such as cellular phones have allowed users to call from different locations. Many of these locations are inamicable to speech recognition systems because they may introduce a significant amount of background noise. The background noise jumbles the voiced input that the user provides through her cellular phone. For example, a user may be calling from a busy street with car engine noises jumbling the voiced input. Even traditional telephones may be used in a noisy environment, such as in the home with many voices in the background as during a social event. To further compound the speech recognition difficulty, users may vocalize their own noise words that do not have meaning, such as “ah” or “um”. These types of words further jumble the voiced input to a speech recognition system.

The present invention overcomes these disadvantages as well as others. In accordance with the teachings of the present invention, a computer-implemented speech recognition method and system are provided for handling noise contained in a user input speech. The input speech from a user contains environmental noise, user vocalized noise, and useful sounds. A domain acoustic noise model is selected from a plurality of candidate domain acoustic noise models that substantially matches the acoustic profile of the environmental noise in the user input speech. Each of the candidate domain acoustic noise models contains a noise acoustic profile specific to a pre-selected domain. An environmental noise language model is adjusted based upon the selected domain acoustic noise model and is used to detect the environmental noise within the user input speech. A vocalized noise model is adjusted based upon the selected domain acoustic noise model and is used to detect the vocalized noise within the user input speech. A language model is adjusted based upon the selected domain acoustic noise model and is used to detect the useful sounds within the user input speech. Speech recognition is performed upon the user input speech using the adjusted environmental noise language model, the adjusted vocalized noise model, and the adjusted language model.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawing(s), wherein:

FIG. 1 is a system block diagram depicting the components used to handle noise within a speech recognition system.

### DETAILED DESCRIPTION OF THE PREFERRED EMBODIMENT

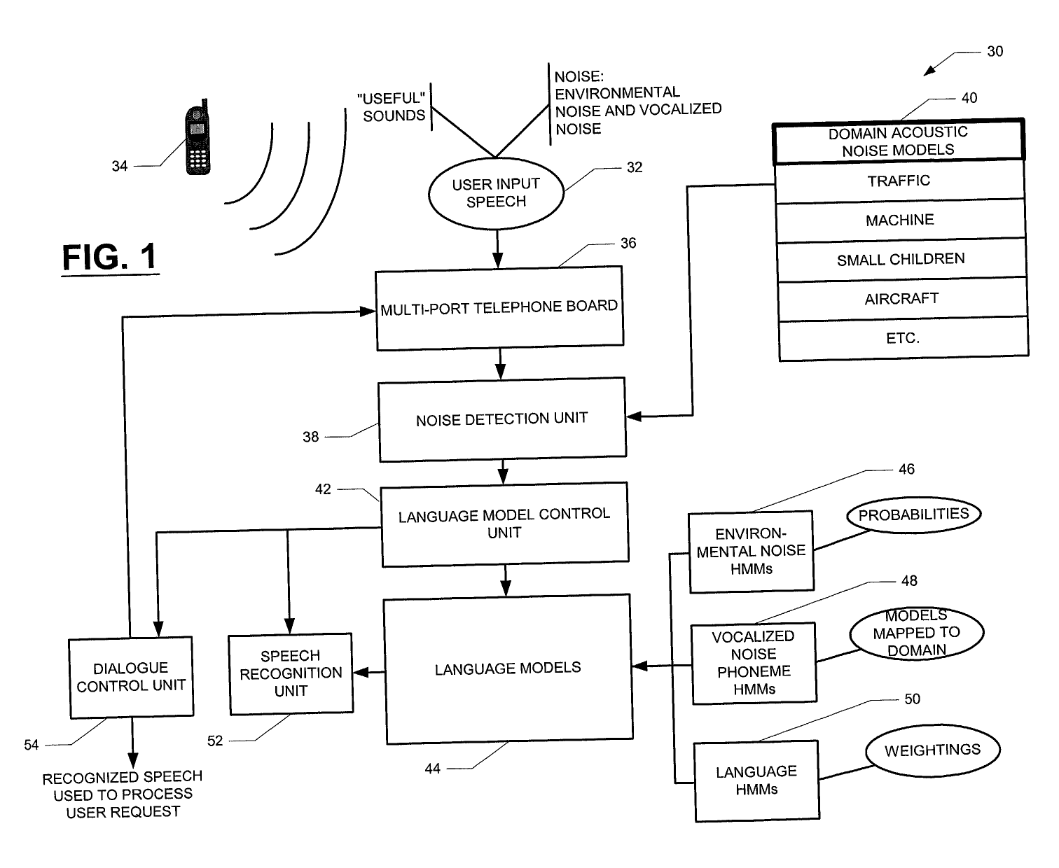

FIG. 1 depicts a noise normalization system 30 of the present invention. The noise normalization system 30 detects noise type (i.e., quality) and intensity that accompanies user input speech 32. A user may be using her cellular phone 34 to interact with a telephony service in order to request a weather service. The user provides speech input 32 through her cellular phone 34. The noise normalization system 30 removes an appreciable amount of noise that is present in the user input speech 32 before a speech recognition unit receives the user input speech 32.

The user speech input 32 may include both environmental noise and vocalized noise along with “useful” sounds (i.e., the actual message the user wishes to communicate to the system 30). Environmental noise arises due to miscellaneous noise surrounding the user. The type of environmental noise may vary because there are many environments in which the user may be using her cellular phone 34. Vocalized noises include sounds introduced by the user, such as when the user vocalizes an “um” or an “ah” utterance.

The noise normalization system 30 may use a multi-port telephone board 36 to receive the user input speech 32. The multi-port telephone board 36 accepts multiple calls and funnels the user input speech for a call to a noise detection unit 38 for preliminary noise analysis. Any type of multi-port telephone board 36 as found within the field of the invention may be used, as for example from Dialogic Corporation located in New Jersey. However, it should be understood that any type of incoming call handling hardware as commonly used within the field of the present invention may be used.

The noise detection unit 38 estimates the intensity of the background noise, as well as the type of noise. This estimation is performed through the use of domain acoustic noise models 40. Domain acoustic noise models 40 are acoustic wave form models of a particular type of noise. For example, a domain acoustic noise model may include: a traffic noise acoustic model (which are typically low-frequency vehicle engine noises on the road); a machine noise acoustic model (which may include mechanical noise generated by machines in a work room); a small children noise acoustic model (which include higher pitch noises from children); and an aircraft noise acoustic model (which may be the noise generated inside the airplane). Other types of domain acoustic noise models may be used in order to suit the environments from which the user may be calling. The domain acoustic noise model may be any type of model as is commonly used within the field of the present invention, such as the pitch of the noise being plotted against time.

The noise detection unit 38 examines the noise acoustic profile (e.g., pitch versus time) of the user input speech with respect to the acoustic profile of the domain acoustic noise models 40. The noise acoustic profile of the user input speech is determined by models trained on the time-frequency-energy space using discriminative algorithms. The domain acoustic noise models 40 is selected whose acoustic profile most closely matches the noise acoustic profile of the user input speech 32. The noise detection unit 38 provides selected domain acoustic noise model (i.e., the noise type) and the determined intensity of the background noise, to a language model control unit 42.

The language model control unit 42 uses the selected domain acoustic noise model to adjust the probabilities of respective models 44 in various language models being used by a speech recognition unit 52. The models 44 are preferably Hidden Markov Models (HMMs) and include: environmental noise HMM models 46, vocalized noise phoneme HMM models, and language HMM models 50. Environmental noise HMM models 46 are used to further hone which range in the user input speech 32 is environmental noise. They include probabilities by which a phoneme (that describes a portion of noise) transitions to another phoneme. Environmental noise HMM models 46 are generally described in the following reference: “Robustness in Automatic Speech Recognition: Fundamentals and Applications”, Jean Claude Junqua and Jean-Paul Haton, Kluwer Acadimic Publishers, 1996, pages 155-191.

Phoneme HMMs 48 are HMMs of vocalized noise, and include probabilities for transitioning from one phoneme that describes a portion of a vocalized noise to another phoneme. For each vocalized noise type (e.g., “um” and “ah”) there is a HMM. There is also a different vocalized noise HMM for each noise domain. For example, there is a HMM for the vocalized noise “um” when the noise domain is traffic noise, and another HMM for the vocalized noise “ah” when the noise domain is machine noise. Accordingly, the vocalized noise phoneme models are mapped to different domains. Language HMM models 50 are used to recognize the “useful” sounds (e.g., regular words) of the user input speech 32 and include phoneme transition probabilities and weightings. The weightings represent the intensity range at which the phoneme transition occurs.

The HMMs 46, 48, and 50 use bi-phoneme and tri-phoneme, bi-gram and tri-gram noise models for eliminating environmental and user-vocalized noise from the request as well as recognize the “useful” words. HMMs are generally described in such references as “Robustness In Automatic Speech Recognition”, Jean Claude Junqua et al., Kluwer Academic Publishers, Norwell, Mass., 1996, pages 90-102.

The language model control unit 42 uses the selected domain acoustic noise model to adjust the probabilities of respective models 44 in various language models being used by a speech recognition unit 52. For example when the noise intensity level is high for a particular noise domain, the probabilities of the environmental noise HMMs 46 model are increased, making the recognition of words more difficult. This reduces the false mapping of recognized words by the speech recognition unit. When the noise intensity is relatively high, the probabilities are adjusted differently based upon the noise domain selected by the noise detection unit 38. For example, the probabilities of the environmental noise HMMs 46 are adjusted differently when the noise domain is a traffic noise domain versus a small children noise domain. In the example when the noise domain is a traffic noise domain, the probabilities of the environmental noise HMMs 46 are adjusted to better recognize the low-frequency vehicle engine noises typically found on the road. When the noise domain is a traffic noise domain, the probabilities of the environmental noise HMMs 46 are adjusted to better recognize the higher-frequency pitches typically found in an environment of playful children.

To better detect vocalized noises, the vocalized noise phoneme HMMs 48 are adjusted so that the vocalized noise phoneme HMM contains only the vocalized noise phoneme HMM that is associated with the selected noise domain. The associated vocalized noise phoneme HMM is then used within the speech recognition unit.

The weightings of the language HMMs are adjusted based upon the selected noise domain. For example, the weightings of the language HMMs 50 are adjusted differently when the noise domain is a traffic noise domain versus a small children noise domain. In the example when the noise domain is a traffic noise domain, the weightings of the language HMMs 50 are adjusted to better overcome the noise intensity of the low-frequency vehicle engine noises typically found on the road. When the noise domain is a traffic noise domain, the weightings of the language HMMs 50 are adjusted to better overcome the noise intensity of the higher-frequency pitches typically found in an environment of playful children.

The speech recognition unit 52 uses: the adjusted environmental noise HMMs to better recognize the environmental noise; the selected phoneme HMM 48 to better recognize the vocalized noise; and the language HMMs 50 to recognize the “useful” words. The recognized “useful” words and the determined noise intensity are sent to a dialogue control unit 54. The dialogue control unit 54 uses the information to generate appropriate responses. For example, if recognition results are poor while knowing that the noise intensity is high, the dialogue control unit 54 generates a response such as “I can't hear you, please speak louder”. The dialogue control unit 54 is made constantly aware of the noise level of the user's speech and formulates such appropriate responses. After the dialogue control unit 54 determines that a sufficient amount of information has been obtained from the user, the dialogue control unit 54 forwards the recognized speech to process the user request.

As another example, two users with similar requests call from different locations. the noise detection unit 38 discerns high levels of ambient noise with different components (i.e., acoustic profiles) in the two calls. The first call is made by a man with a deep voice from a busy street corner with traffic noise composed mostly of low-frequency engine sounds. The second call is made by a woman with a shrill voice from a day care center with noisy children in the background. The noise detection unit 38 determines that the traffic domain acoustic noise model most closely matches the noise profile of the first call. The noise detection unit 38 determines that the small children domain acoustic noise model most closely matches the noise profile of the second call.

The language model control unit 42 adjusts the models 44 to match both the kind of environmental noise and the characteristics of user vocalizations. The adjusted models 44 enhance the differences for the speech recognition unit 52 to better distinguish among the environmental noise, vocalized noise, and the “useful” sounds in the two calls. The speech recognition uses the adjusted models 44 to predict the range of noise in traffic sounds and in children's voices in order to remove them from the calls. If the ambient noise becomes too loud, the dialogue control unit 54 requests that the user speak louder or call from a different location.

The preferred embodiment described within this document is presented only to demonstrate an example of the invention. Additional and/or alternative embodiments of the invention should be apparent to one of ordinary skill in the art upon after reading this disclosure.

It is claimed:

1. A computer-implemented speech recognition method for handling noise contained in a user input speech, comprising the steps of:
receiving from a user the user input speech that contains environmental noise, user vocalized noise, and useful sounds;
selecting a domain acoustic noise model from a plurality of candidate domain acoustic noise models that substantially matches acoustic profile of the environmental noise in the user input speech, each of said candidate domain acoustic noise models containing a noise acoustic profile specific to a pre-selected domain;
adjusting an environmental noise language model based upon the selected domain acoustic noise model for detecting the environmental noise within the user input speech;
adjusting a vocalized noise model based upon the selected domain acoustic noise model for detecting the vocalized noise within the user input speech;
adjusting a language model based upon the selected domain acoustic noise model for detecting the useful sounds within the user input speech; and
performing speech recognition upon the user input speech using the adjusted environmental noise language model, the adjusted vocalized noise model, and the adjusted language model.
